(19) United States
(12) Patent Application Publication
(10) Pub. No.: US 2005/0134681 A1
(43) Pub. Date: Jun. 23, 2005

(54) Method of inputting information into a mobile digital device

(75) Inventor: Tae-yol Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/994,454

(22) Filed: Nov. 22, 2004

(30) Foreign Application Priority Data
Dec. 18, 2003 (KR) 2003-93169

(51) Int. Cl. H04N 7/14

(52) U.S. Cl. 348/14.01

(57) ABSTRACT

A method is provided for controlling the input of characters and numbers using function switches installed on a mobile digital device. In particularly, a method of controlling a mobile digital device so that a user can input characters and numbers to the mobile digital device, which includes a display panel and input switches that are arranged around the display panel is provided. The method includes: displaying icons for inputting characters that correspond to the input switches on the display panel, and when an input switch is pressed, receiving a signal related to the icon that corresponds to the pressed input switch.

### BACKGROUND OF THE INVENTION

This application claims the priority of Korean Patent Application No. 2003-93169, filed on Dec. 18, 2003, in the Korean Intellectual Property Office, the disclosure of which is incorporated herein in its entirety by reference.

1. Field of the Invention

The present invention relates to a method of controlling a mobile digital device, and more particularly, to a method of controlling the input of characters into a mobile digital device.

2. Description of the Related Art

There has been a rise in the usage of mobile digital devices as their functionalities have improved. The ability to enter characters, utilizing a user-friendly method, to edit the device functionality has become an essential part of these mobile digital devices.

A method of inputting characters in mobile devices, such as digital cameras, is disclosed in Korea Utility Model Publication Nos. 1997-0063983 and 1997-0063993. The former discloses a digital video camera that displays a character window on a display panel, and the characters are sensed by and input into the digital video camera by touching the character window with one's fingers. The latter discloses a digital video camera that displays a character window on a display panel. Characters are then input into the digital video camera by moving the characters into the input window with a cursor. Also, U.S. Patent Publication No. 2001-0052934 discloses a digital camera that produces characters using voice recognition.

The digital video camera of Korea Utility Model Publication No. 1997-0063983 requires a separate device to sense a touch of the fingers on the digital video camera, and the digital video camera of Korea Utility Model Publication No. 1997-0063993 has the problem of having to move each character using the cursor. Furthermore, the digital camera of U.S. Patent Publication No. 2001-0052934 requires a separate voice recognition device and memory to recognize a user's voice.

### SUMMARY OF THE INVENTION

The present invention provides a method of controlling and editing the functionality of a mobile digital device by using input buttons located on the device to input characters into the device.

According to an aspect of the present invention, there is provided a method of controlling a mobile digital device so that a user can input characters and numbers into the device using a display panel and input buttons located on the device. The method includes displaying, in the display panel, icons for inputting characters or numbers that correspond to the input buttons located on the mobile digital device and, when an input button is pressed, receiving the signal related to the icon that corresponds to the pressed input button.

According to an aspect of the present invention, the cost of the mobile digital device is reduced because it does not require an additional input device. In addition, the user may conveniently input characters and numbers into the mobile digital device using the input buttons included in the mobile digital device.

### BRIEF DESCRIPTION OF THE DRAWINGS

The above and other features and advantages of the present invention will become more apparent by describing in detail exemplary embodiments thereof with reference to the attached drawings in which:

FIG. 1 is a back view of one example of a mobile digital device, a digital camera, that illustrates an embodiment of the present invention;

FIG. 2 is a front view of the display panel, in this case a liquid crystal display, illustrating an example of when the English capital letter character mode is selected;

FIG. 3 is a front view of the display panel illustrating an example of when the English small letter character mode is selected;

FIG. 4 is a front view of the display panel illustrating an example of when the number mode is selected;

FIG. 5 is a front view of a display panel illustrating an example of when the modification mode is selected; and

FIG. 6 is a front view of a display panel illustrating an example of when the end-input confirmation mode is selected.

### DETAILED DESCRIPTION OF THE INVENTION

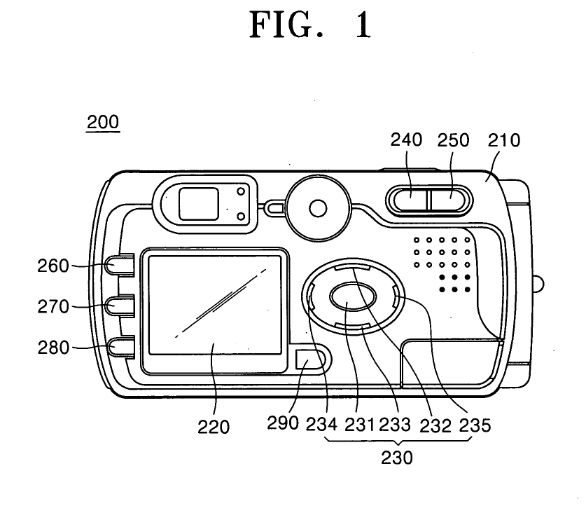

FIG. 1 is the rear view of a mobile digital device, a camera, 200 according to the present invention. Referring to FIG. 1, a liquid crystal display panel 220 is located in the lower left side of the camera case 210. A plurality of input buttons are arranged around the liquid crystal display panel. A “play & pause” button 260, a “MF/delete” button 270, and a “LCD/information” button 280 are respectively located from top to bottom on the left side of the liquid crystal display panel 220. A “wide/thumbnail” button 240 and a “tele” button 250 are located near the top right of the case 210 and, located to the right of the display panel 220, is a five-function mechanism 230 comprised of a “menu/OK” button 231 and four directional buttons 232, 233, 234, and 235. In addition, a play button 290 is located near the bottom right corner of the liquid crystal display panel 220. When a user presses an input button, a controller (not shown) of the digital camera 200 receives a signal corresponding to the pressed input button.

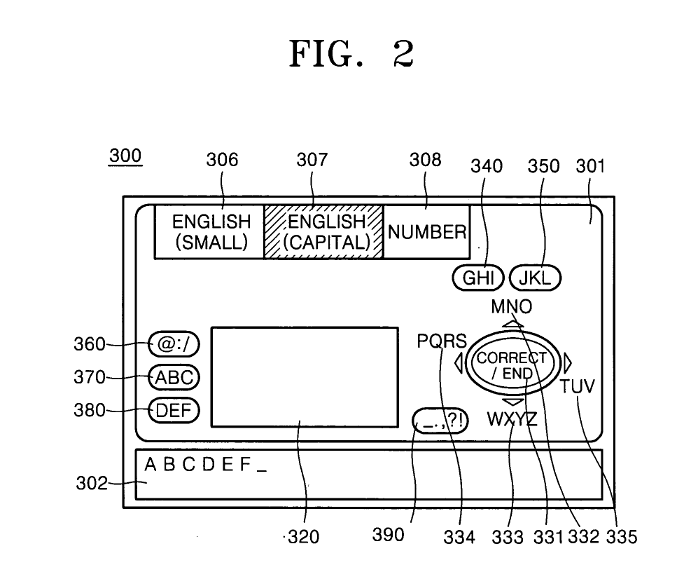

FIG. 2 illustrates the icons that are displayed by the controller on the liquid crystal display panel 300 when the English capital letter character mode of this invention is selected by the user. The liquid crystal display panel 300 is divided into two main windows, first and second regions 301 and 302. In the top portion of the first region 301, an English small letter character mode icon 306, an English capital letter character mode icon 307, and a number mode icon 308 are displayed. The shaded icon indicates the input mode that is currently activated. In the present example, the English capital letter character mode icon 307 is activated. The English capital letter character mode is the default input mode. The relative locations of the plurality of icons displayed in the first region 301 correspond to the relative locations of the input buttons shown in FIG. 1. Therefore, icons 360, 370, and 380, which respectively correspond to the “play & pause” button 260, the “MF/delete” button 270, and the “LCD/information” button 280, are displayed from top to bottom to the left the icon 320 which corresponds to the liquid crystal display panel 220. Also, the icons 331, 332, 333, 334, and 335 that correspond respectively to the “menu/OK” button 231 and the four directional buttons 232, 233, 234, and 235 of the five-function mechanism 230 shown in FIG. 1 are located to the right of the liquid crystal display panel icon 320 in FIG. 2. Icon 340 and icon 350 that correspond to the “wide/thumbnail” button 240 and the “tele” button 250, respectively, are displayed above the icon 331, icon 332, icon 333, icon 334, and icon 335. Icon 390 that corresponds to the play button 290 is displayed at the bottom right corner of icon 320. As illustrated in FIG. 2, English capital letter characters from “A” to “Z” and characters “@”, “:”, “/”, “-”, “.”, “,”, “?”, and “!” are written on icons 340, 350, 334, 335, 332, 333, 360, 370, 380, and 390 such that each character may be input by pressing the input buttons that correspond to the displayed icons 340, 350, 334, 335, 332, 333, 360, 370, 380, and 390. If there is a character a user wants to input, the user finds the icon on the liquid crystal display panel 300 that corresponds to the character and presses the input button that corresponds to that icon. The controller then receives a signal from the input button and displays the corresponding character in the second region 302.

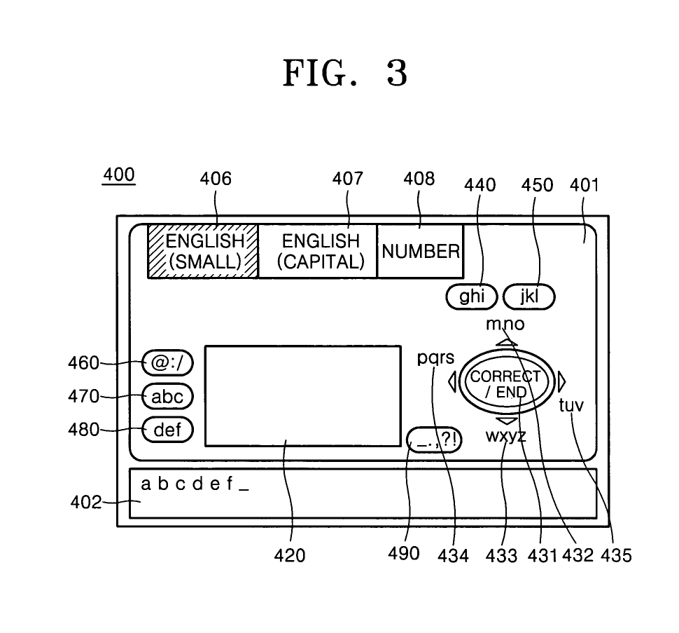

FIG. 3 illustrates the icons that are displayed on the liquid crystal display panel 400 when the English small letter character mode is selected by the user. Referring to FIG. 3, in the top portion of region 401, the English small letter character mode icon 406, the English capital letter character mode icon 407, and the number mode icon 408 are displayed. The English small letter character mode icon 406 is shaded and is therefore activated in the present example. Similar to the icons displayed when the English capital letter character mode icon 307 is activated, icons 431, 440, 450, 434, 435, 432, 433, 460, 470, 480, 490, and 420 are displayed when the English small letter character mode icon is activated. English small letter characters from “a” to “z” and characters “@”, “:”, “/”, “-”, “.”, “,”, “?”, and “!” are written on icons 440, 450, 434, 435, 432, 433, 460, 470, 480, and 490 such that each character may be input by pressing the input buttons that correspond to the displayed icons 440, 450, 434, 435, 432, 433, 460, 470, 480, and 490. When the input button that corresponds to an icon is pressed, the controller receives a signal from the input button and displays the appropriate character in region 402.

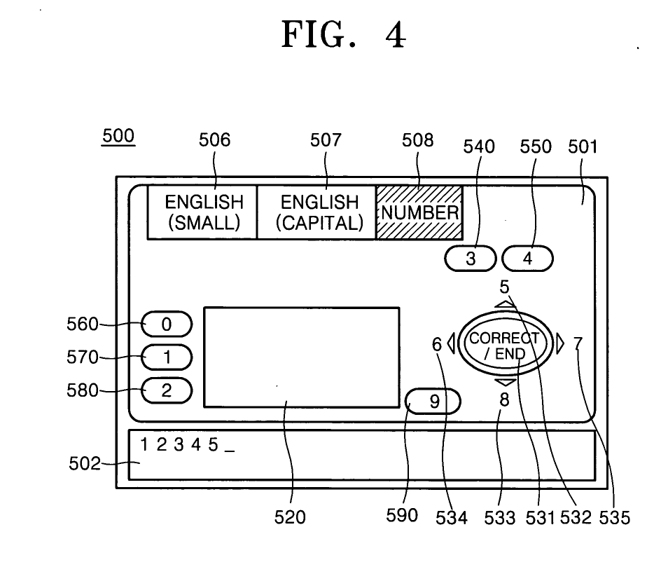

FIG. 4 illustrates the icons that are displayed on the liquid crystal display panel 500 when the number mode is selected by the user. Referring to FIG. 4, in the top portion of region 501, the English small letter character mode icon 506, the English capital letter character mode icon 507, and the number mode icon 508 are displayed. The number mode icon 508 is shaded and is therefore activated in the present example. Similar to the English capital letter character mode and the English small letter character mode, icons 531, 540, 550, 534, 535, 532, 533, 560, 570, 580, 590, and 520 are displayed. Numbers from “0” to “9” are written on icons 540, 550, 534, 535, 532, 533, 560, 570, 580, and 590, such that each number may be input by pressing the input button that correspond to the appropriate icon. When the input button that corresponds to the icon is pressed, the controller receives a signal from the input button and displays the corresponding number in region 502.

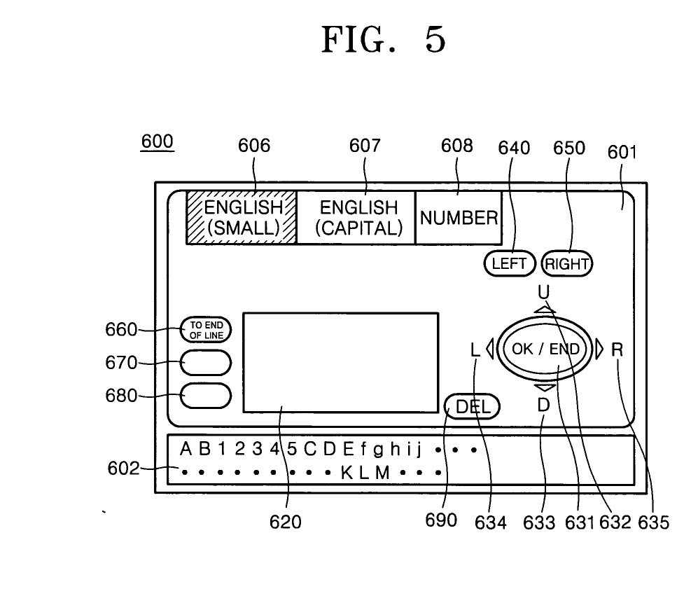

If the user is in the English small letter character mode, the English capital letter character mode or the number mode and wants to change the input mode or wants to correct an input character or number, the user presses button the “menu/OK” button 231, which corresponds to icons 331, 441 and 531 respectively, for a predetermined amount of time, for example, about one second. This causes the icons for the modification mode to be displayed on the display panel 600 as illustrated in FIG. 5. As illustrated in FIG. 5, icons 631, 640, 650, 634, 635, 632, 633, 660, 670, 680, 690, and 620 that correspond to the input buttons and the display panel are displayed in a first region 601. In addition, the icons for the English small letter character mode 606, the English capital letter character mode 607, and the number mode 608 are displayed in the top portion of region 601. In the present example illustrated by FIG. 5, the English small letter character mode icon 606 is shaded and is the input mode that is activated.

The icons 640 and 650 show the scrolling direction for the “wide/thumbnail” button 240 and the “tele” button 250 that are used to select the input mode. When the “wide/thumbnail” button 240 that corresponds to icon 640 is pressed, the icon to the left of the currently shaded input mode icon becomes shaded, and when the “tele” button 250 that corresponds to icon 650 is pressed, the icon to the right of the currently shaded input mode icon becomes shaded. When the “menu/OK” button 231, which corresponds to icon 631, is then pressed for a predetermined amount of time, the controller changes the input mode to that indicated by the newly shaded icon.

In addition to changing the input mode, characters or numbers can also be changed while in the modification mode. As an example of correcting characters, as illustrated in FIG. 5, when the “play & pause” button 260 that corresponds to icon 660 is pressed, a cursor (not shown) in region 602 moves to the last character. When the directional buttons 232, 233, 234, and 235 that correspond to the directional icons 632, 633, 634, and 635 are pressed, the cursor moves up, down, left or right, respectively, to move to the desired character shown in region 602. When the play button 290 that corresponds to icon 690 is pressed, the character in front of the cursor is deleted. The controller displays the input mode again when the “menu/OK” button 231 that corresponds to icon 631 is pressed for a predetermined amount of time after the input characters are corrected.

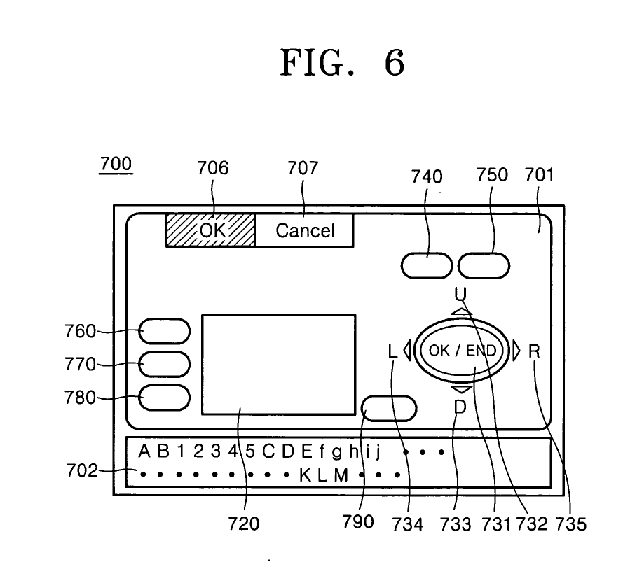

In the input mode or the modification mode, when the “menu/OK” button 231 that corresponds to icons 331, 431, 531, and 631 is pressed for a predetermined amount of time, for example more than one second, a liquid crystal display panel 700 as illustrated in FIG. 6 corresponding to an end-input confirmation mode is displayed. Referring to FIG. 6, an “OK” icon 706 and a “cancel” icon 707 are displayed in the top portion of the liquid crystal display panel 700. Icons 731, 740, 750, 734, 735, 732, 733, 760, 770, 780, 790, and 720 that correspond to input buttons and the display panel are also displayed. The user can shade the “OK” icon 706 and the “cancel” icon 707 using the directional buttons 234 and 235 that correspond to directional icons 734 and 735. That is, the directional button 234 that corresponds to icon 734 will shade the icon to the left, and directional button 235 that corresponds to icon 735 will shade the icon to the right. If the “menu/OK” button 231 that corresponds to icon 731 is pressed when the “OK” icon 706 is shaded, the controller ends the character or number inputting mode. Conversely, if the “menu/OK” button 231 that corresponds to icon 731 is pressed when the “cancel” icon 707 is shaded, the controller displays the character or number input mode again.

In a method of controlling a mobile digital device according to the present invention, icons that correspond to input buttons are displayed on a display panel and characters or numbers are input when a user presses input buttons that correspond to the displayed icons. Therefore, the convenience of the user is increased. In addition, a mobile digital device that adopts the method of the present invention does not require a separate sensor for inputting information, thereby lowering the cost of the mobile digital device. Furthermore, since it is possible to input characters or numbers by using the input buttons on the mobile digital device, the user may use the mobile digital device with ease.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of inputting information into a mobile digital device which includes a display and a plurality of input mechanisms, the method comprising:
displaying a plurality of icons on the display where at least one of the icons corresponds to at least one of the plurality of input mechanisms, and wherein said at least one icon has an associated function;
triggering an input mechanism and receiving a signal from the input mechanism; and
performing the function associated with the icon that corresponds to the triggered input mechanism.

2. The method of claim 1 where at least one of the icons includes a portion that appears similar to the physical appearance of at least one of the input mechanisms.

3. The method of claim 1 where a plurality of icons are arranged on the display similar to the corresponding physical arrangement of the input mechanisms on the mobile digital device.

4. The method of claim 3 where the mobile digital device is a digital camera.

5. The method of claim 3 where at least some of the icons include a portion that appears similar to the physical appearance of the corresponding input mechanisms.

6. The method of claim 5 where the mobile digital device is a digital camera.

7. The method of claim 1 where at least a portion of the display is used to display alphanumeric characters input from the input mechanisms.

8. The method of claim 1 where at least one function associated with at least one icon is to generate an alphanumeric character that corresponds to the input mechanism.

9. The method of claim 1 further comprising the step of changing the mode of the display such that at least some of the icons displayed and their associated functions are changed.

10. The method of claim 1 wherein the plurality of input mechanisms include input mechanisms selected from the group comprising buttons, switches, levers and knobs.

11. The method of claim 1 wherein the plurality of functions associated with icons include functions selected from the group comprising inputting characters, inputting numbers, deleting a character, deleting a number, selecting English small letter mode, selecting English capital letter mode, selecting number mode, changing the mode, and positioning a cursor to select the character or number to be deleted.

12. A method of inputting information into a mobile digital device which includes a display and a plurality of input mechanisms of predetermined shape arranged in a predetermined arrangement on the mobile digital device, the method comprising the steps of:
displaying a plurality of icons on the display where at least some of the icons include a portion that appears similar to the predetermined shape of corresponding input mechanisms, and include a portion that denotes a function associated with the icon;
receiving a signal from at least one of the input mechanisms; and
performing the function associated with the icon that corresponds to the input mechanism from which a signal was received.

13. The method of claim 12 further comprising the step of arranging the icons on the display in a manner that is similar to the predetermined arrangement of the corresponding input mechanisms on the mobile digital device.

14. The method of claim 12 where at least a portion of the display is used to display alphanumeric characters input from the input mechanisms.

15. The method of claim 12 further comprising the step of changing the mode of the display such that at least some of the icons displayed and their associated functions are changed.

16. The method of claim 12 where the mobile digital device is a digital camera.

17. A mobile digital device comprising:
at least one display;
a plurality of input mechanisms each having a predetermined shape and arranged in a predetermined arrangement on the mobile digital device;
a display driver that displays a plurality of icons on the display that correspond to at least some of the input mechanisms and have an associated function; and
data processing means for sensing the triggering of an input mechanism and performing the function associated with the icon that corresponds to the input mechanism.

18. A mobile digital device as claimed in claim 17 where the display is generally rectangular, where at least some of the plurality of input mechanisms are arranged on a generally rectangular surface of the mobile digital device, and where the display driver arranges the icons on the display similar to the arrangement of the input mechanisms on the mobile digital device.

19. A mobile digital device according to claim 17 where at least one of the functions associated with the icons that correspond to the input mechanisms is to input alphanumeric characters.

20. The mobile digital device according to claim 19 where at least a portion of the display is used to display input alphanumeric characters.
